(19) United States
(12) Patent Application Publication
(10) Pub. No.: US 2007/0155245 A1
(43) Pub. Date: Jul. 5, 2007

(54) Electrical connector having an elastic pressing member with an elastic arm

(76) Inventor: Chou Hsuan Tsai, Hsin-Chuang City (TW)

Correspondence Address: PRO-TECHTOR INTERNATIONAL SERVICES, 20775 NORADA CT., SARATOGA, CA, 95070, US

(21) Appl. No.: 11/439,295

(22) Filed: May 22, 2006

(30) Foreign Application Priority Data
Dec. 30, 2005 (TW) 094147359

(51) Int. Cl. H01R 24/00

(52) U.S. Cl. 439/637

(57) ABSTRACT

An electrical connector to be connected to a circuit board having two edge surfaces, on which connection points are disposed. The connector includes a plastic base and terminals. The plastic base has a longitudinal shape, two rows of terminal slots, and a longitudinal connection slot between the two rows of terminal slots. The connection slot has an opening facing upwards such that the circuit board can be inserted, from top to bottom, for connection. The terminals are disposed in the terminal slots of the plastic base. Each terminal has an elastic contact to be electrically connected to a connection point of the circuit board, and a pin portion extending out of a bottom of the plastic base. An elastic pressing member is disposed on the plastic base. The elastic pressing member has an elastic arm pressing against the circuit board.

### BACKGROUND OF THE INVENTION

1. Field of the Invention

The invention relates to an electrical connector, and more particularly to an edge card electrical connector.

2. Description of the Related Art

Referring to FIGS. 1 and 2, an edge card electrical connector is to be electrically connected to an edge-card-type circuit board 20 having two edge surfaces, on which connection points 21 are disposed separately. The connector includes a plastic base 10 formed with two rows of terminal slots 11, a longitudinal connection slot 12 formed between the two rows of terminal slots 11, terminals 15 disposed in the terminal slots 11 of the plastic base 10, and two board engaging elements 19 disposed on bottoms of two sides of the plastic base 10. Each terminal 15 has an elastic contact 16 to be electrically connected to a connection point of the circuit board 20 and a pin portion 17 extending out of a bottom of the plastic base. The board engaging elements 19 engage with the bonded circuit board.

When the circuit board 20 is inserted into the plastic base 10, each connection point 21 on two surfaces of the circuit board 20 elastically contacts the contact 16 of each terminal 15. Thus, the electrical connection can be achieved and the circuit board 20 can be tightly clamped through each terminal 15.

The conventional structure for clamping the circuit board mainly utilizes the contacts 16 of the terminals 15 to clamp the circuit board 20 tightly. In order to make the circuit board 20 be inserted into and held in the connection slot 12 firmly, the terminal 15 must have the proper elasticity. Thus, the terminal must have the enough material thickness, and a too-thin metal plate cannot be used such that the material cost cannot be easily reduced. In addition, the board engaging elements 19 must be added in order to engage with the bonded circuit board.

### SUMMARY OF THE INVENTION

It is therefore an object of the invention to provide an electrical connector having an elastic pressing member for pressing a circuit board so that the material cost of the terminals can be reduced.

Another object of the invention is to provide an electrical connector having an elastic pressing member and a board engaging portion integrally formed at a bottom end of the elastic pressing member. Thus, the effect of engaging the bonded circuit board can be achieved without any board engaging element.

Furthermore, the bottom end of the elastic pressing member may be further formed with a board engaging portion to further engage the bonded circuit board.

### BRIEF DESCRIPTION OF THE DRAWINGS

FIG. 1 is a pictorially exploded view showing an electrical connector and a circuit board according to the prior art.

FIG. 2 is a cross-sectional view showing the electrical connector and the circuit board that are combined together according to the prior art.

FIG. 3 is a pictorially exploded view showing an electrical connector according to a first embodiment of the invention.

FIG. 4 is a cross-sectional view showing the electrical connector of the first embodiment, which has not been connected to a circuit board yet.

FIG. 5 is a cross-sectional view showing the electrical connector of the first embodiment, which has been connected to the circuit board.

FIG. 6 is a pictorially exploded view showing an electrical connector according to a second embodiment of the invention.

FIG. 7 is a cross-sectional view showing an electrical connector of a third embodiment, which has not been connected to a circuit board yet.

FIG. 8 is a cross-sectional view showing the electrical connector of the third embodiment, which has been connected to the circuit board.

FIG. 9 is a pictorially exploded view showing an electrical connector according to a fourth embodiment of the invention.

FIG. 10 is a top view showing the electrical connector of the fourth embodiment, which has been connected to a circuit board.

FIG. 11 is a cross-sectional view showing the electrical connector of the fourth embodiment, which has been connected to the circuit board.

FIG. 12 is a pictorially exploded view showing an electrical connector according to a fifth embodiment of the invention.

FIG. 13 is a pictorially exploded view showing an electrical connector according to a sixth embodiment of the invention.

FIG. 14 is a pictorially exploded view showing an electrical connector according to a seventh embodiment of the invention.

FIG. 15 is a pictorially exploded view showing an electrical connector according to an eighth embodiment of the invention.

FIG. 16 is a pictorial view showing an elastic pressing member according to the eighth embodiment of the invention.

FIG. 17 is a pictorially assembled view showing the electrical connector according to the eighth embodiment of the invention.

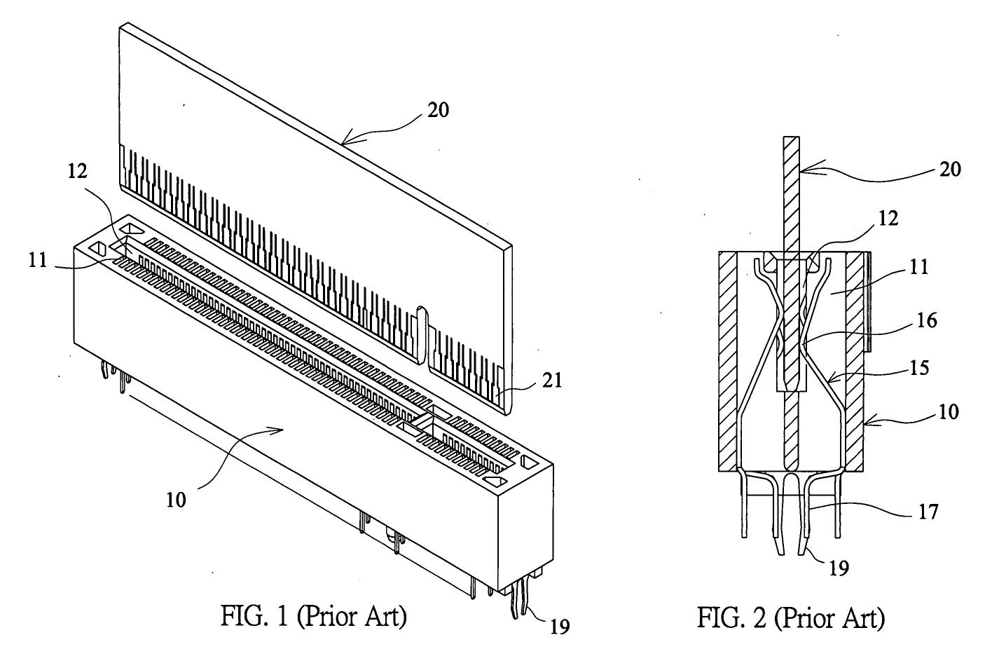

### DETAILED DESCRIPTION OF THE INVENTION

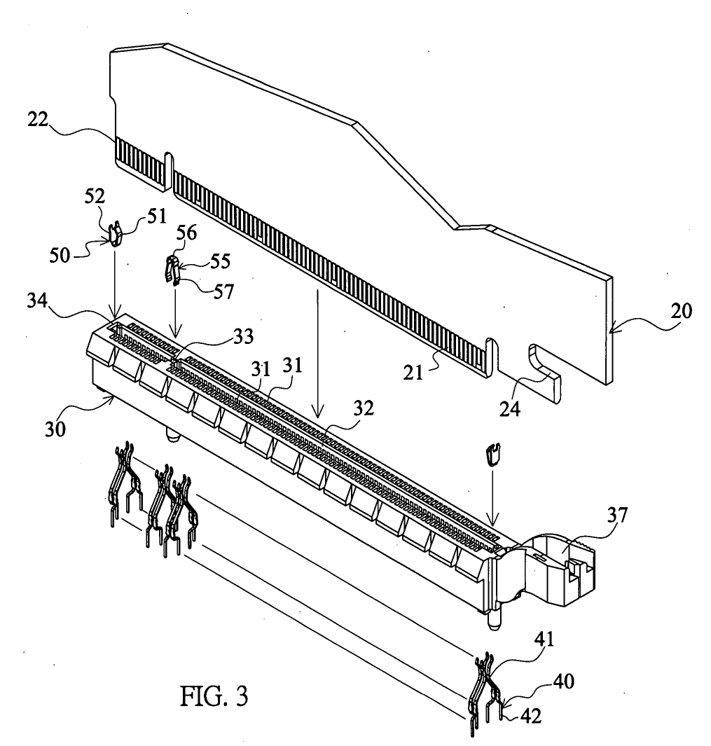

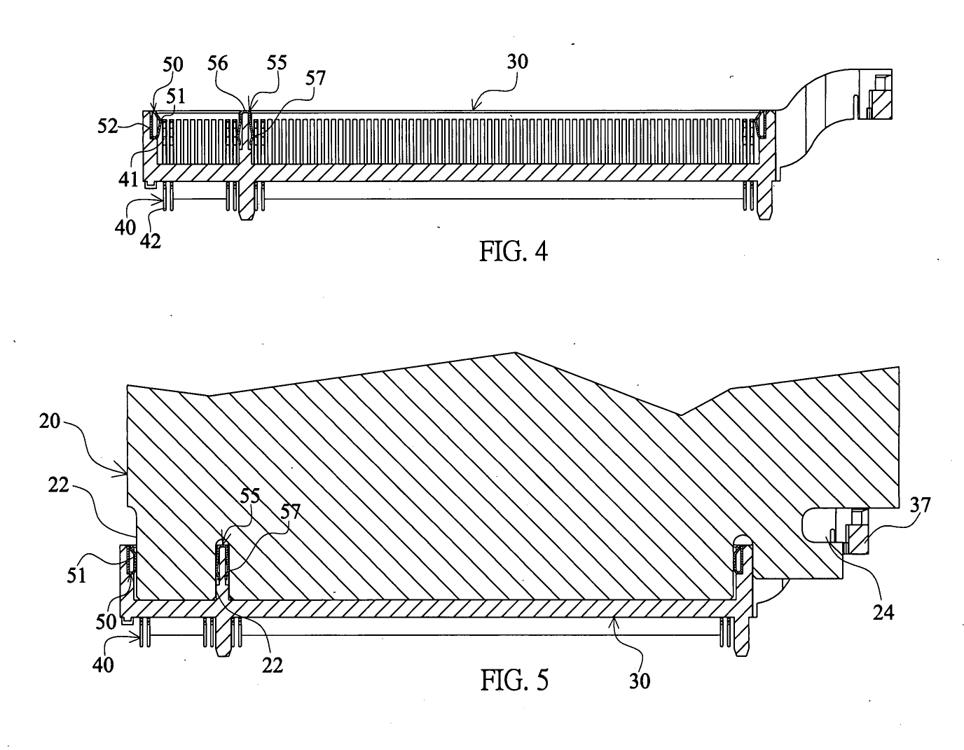

Referring to FIGS. 3 and 4, an electrical connector, such as a PCI EXPRESS connector of this embodiment is to be connected to an edge card type circuit board 20 having two edge surfaces, on which connection points 21 are disposed. One side of the circuit board 20 is formed with a notch 24. The connector includes a plastic base 30, terminals 40, two first elastic pressing members 50 and one second elastic pressing member 55.

The plastic base 30 has a longitudinal shape and is formed with two rows of terminal slots 31, and one longitudinal connection slot 32 between the two rows of terminal slots 31. The opening of the connection slot 32 faces upwards such that the circuit board 20 can be inserted, from top to bottom, for connection. The plastic base 30 is also formed with a spacer 33 for dividing the connection slot 32 into two regions with different sizes, and two sides of the connection slot 32 are formed with slots 34. In addition, an engaging device 37 is disposed at one side of the connection slot 32. The engaging device 37 may movably engage with the notch 24 at one side of the circuit board 20 to prevent the circuit board 20 from separating from the plastic base 30 upwards. Detailed descriptions of the engaging device 37 will be omitted since the engaging device 37 is not the key point of this invention.

The terminal 40 is disposed in the terminal slot 31 of the plastic base 30 and has an elastic contact 41 electrically connected to the connection point 21 of the circuit board 20 and one pin portion 42 extending out of the bottom of the plastic base 30.

The first elastic pressing member 50 is made of a metal material and includes an elastic arm 51 and a fixing portion 52 fixed to the slots 34 at two sides of the plastic base 30.

The second elastic pressing member 55 is made of a metal material and includes a fixing portion 56 and two symmetrical elastic arms 57. The fixing portion 56 is fixed onto the spacer 33 of the plastic base 30.

As shown in FIG. 5, when the circuit board 20 is inserted into the plastic base 30, the connection points on two surfaces of the circuit board 20 are in elastic contact with the contacts of the terminals 40, and the elastic arm 51 of the first elastic pressing member 50 and the two elastic arms 57 of the second elastic pressing member 55 can elastically press the lateral side 22 of the circuit board 20. In addition, the engaging device 37 engages with the notch 24 at one side of the circuit board 20 such that the circuit board 20 can not be separated from the plastic base 30.

The elasticity of each of the first elastic pressing member 50 and the second elastic pressing member 55 enables the pressing against the circuit board 20, and thus enhances the force for clamping the circuit board 20. Thus, it is unnecessary to completely utilize the elasticity of the contact 41 of the terminal 40 to clamp the circuit board 20, so the terminals 40 only have to achieve the good electrical connection effects without the need of the very strong elasticity to clamp the circuit board. Thus, a thinner metal material can be used and the material cost can be reduced.

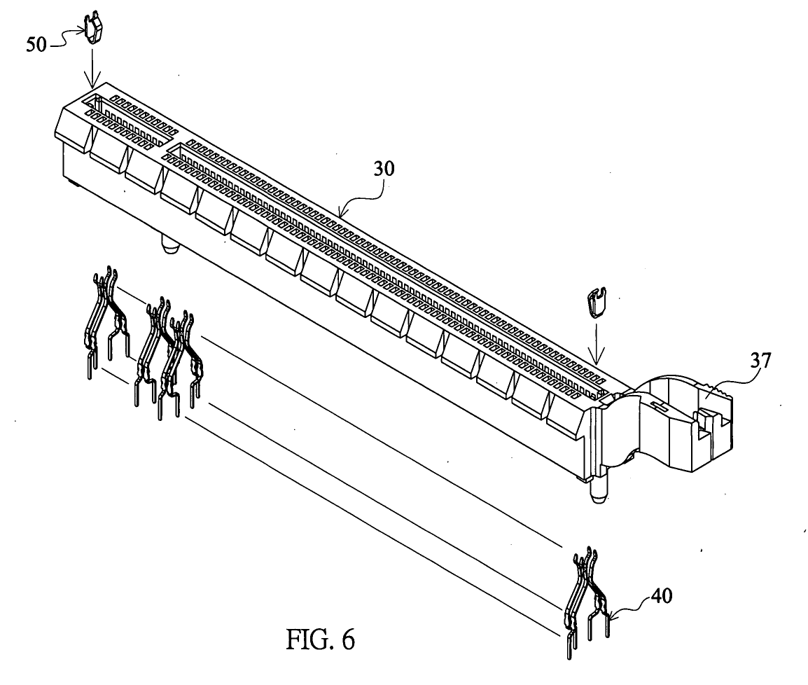

As shown in FIG. 6, the second embodiment of the invention is almost the same as the first embodiment except that this embodiment has only the first elastic pressing member 50 and no second elastic pressing member.

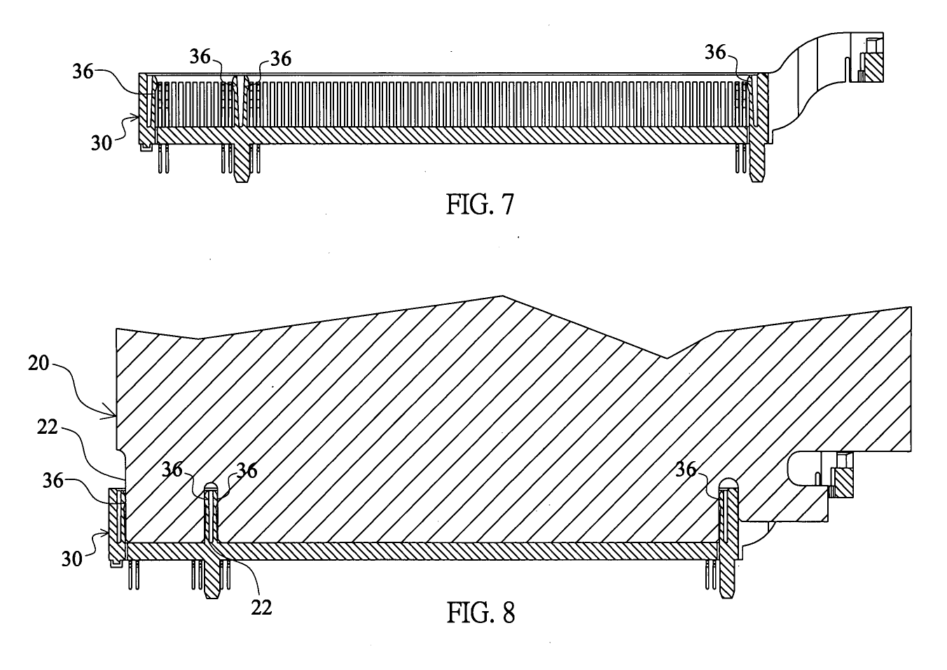

As shown in FIGS. 7 and 8, the third embodiment is almost the same as the first embodiment except that the elastic pressing member of this embodiment and the plastic base 30 are integrally formed by way of injection molding. The plastic base 30 has elastic arms 36 at two ends of the connection slot and the position of the spacer. The elastic arm 36 elastically presses against the lateral side 22 of the circuit board 20.

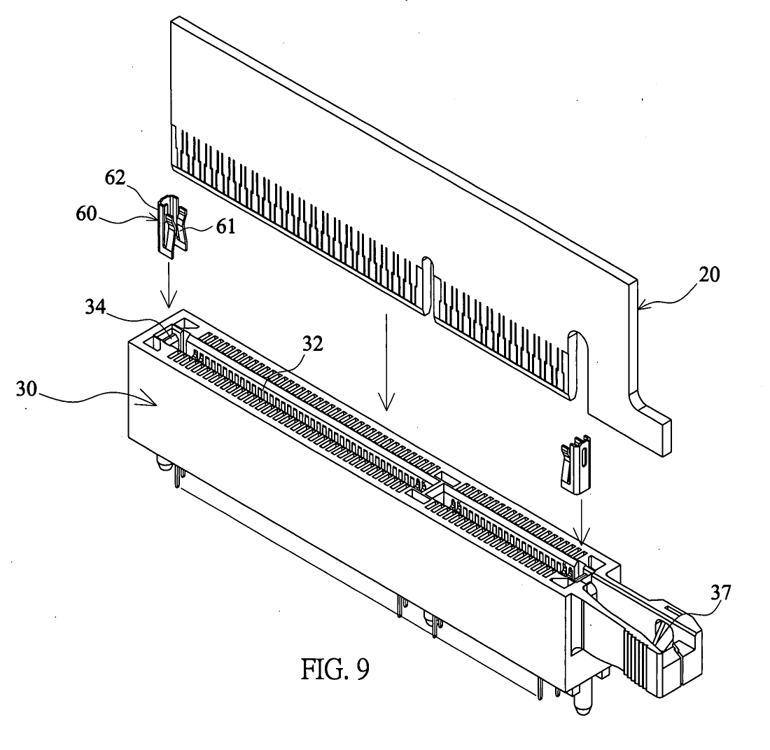

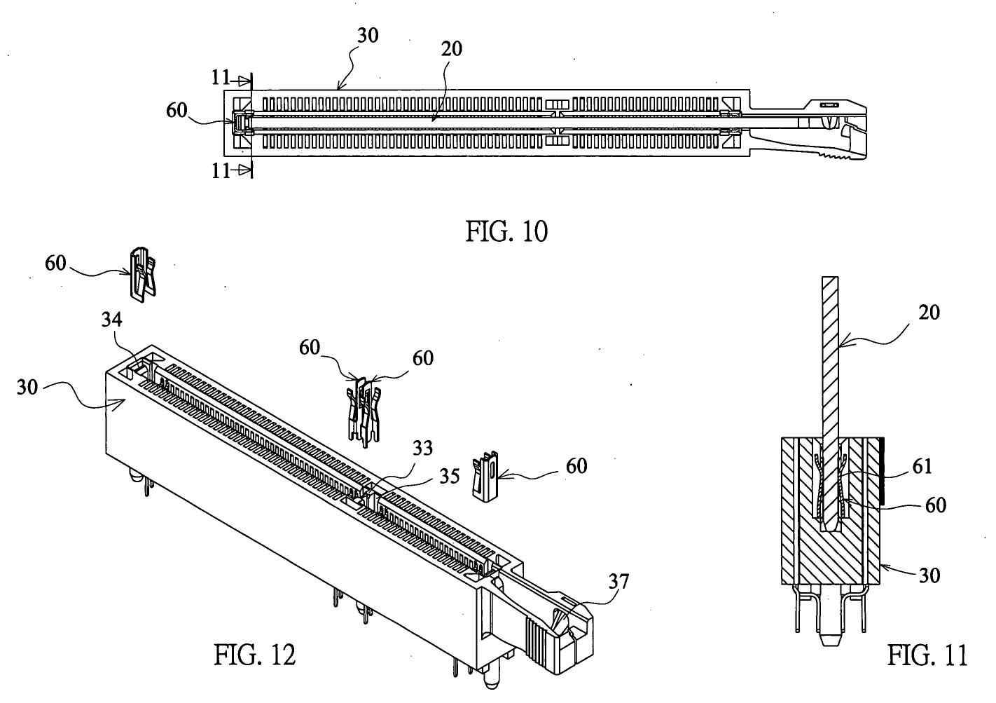

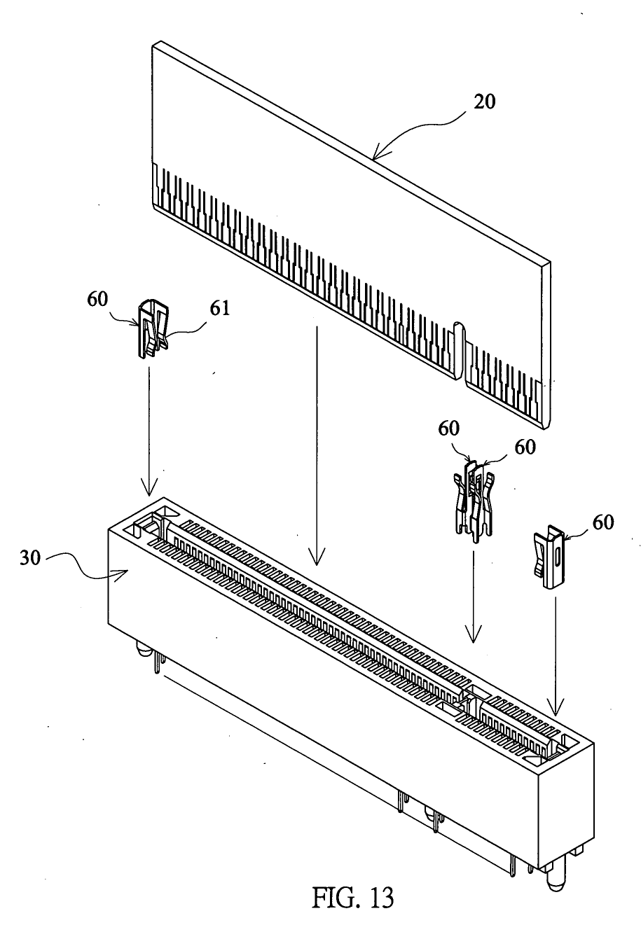

As shown in FIGS. 9 to 11, the fourth embodiment of the invention pertains to another type of electrical connector (typically referred to as an AGP connector). The fourth embodiment is almost the same as the second embodiment because an engaging device 37 for movably engaging with the circuit board is also disposed at one side of the plastic base 30. The difference therebetween is that the fourth embodiment has two elastic pressing members 60, each of which has two elastic arms 61 and one fixing portion 62. The fixing portions 62 are fixed into the slots 34 at two sides of the plastic base 30. The two elastic arms 61 face each other with a gap interposed therebetween. When the circuit board 20 is inserted into the plastic base 30, two plate surfaces of the circuit board 20 may be elastically clamped by the two elastic arms 61 of the elastic pressing member 60.

As shown in FIG. 12, the fifth embodiment of the invention is almost the same as the fourth embodiment except that the fifth embodiment has four elastic pressing members 60, slots 35 are formed at two sides of the spacer 33 of the plastic base 30, and the slots 35 respectively engage with the elastic pressing members 60.

As shown in FIG. 13, the sixth embodiment of the invention pertains to another type of electrical connector (typically referred to as a PCI connector) and is almost the same as the fifth embodiment except that the elastic arms 61 of the elastic pressing members 60 of the sixth embodiment extend from top to bottom. In addition, no engaging device is disposed on one lateral side of the plastic base 30.

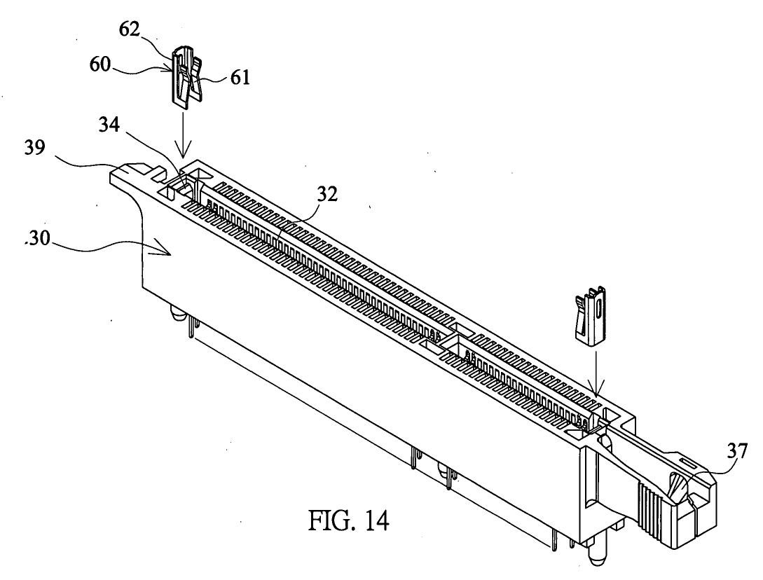

As shown in FIG. 14, the seventh embodiment of the invention pertains to still another type of electrical connector (typically referred to the PCI connector) and is almost the same as the fourth embodiment except that the plastic base 30 of the seventh embodiment has a hooking portion 39 disposed at a lateral side of the engaging device 37 so as to hook one side of the circuit board.

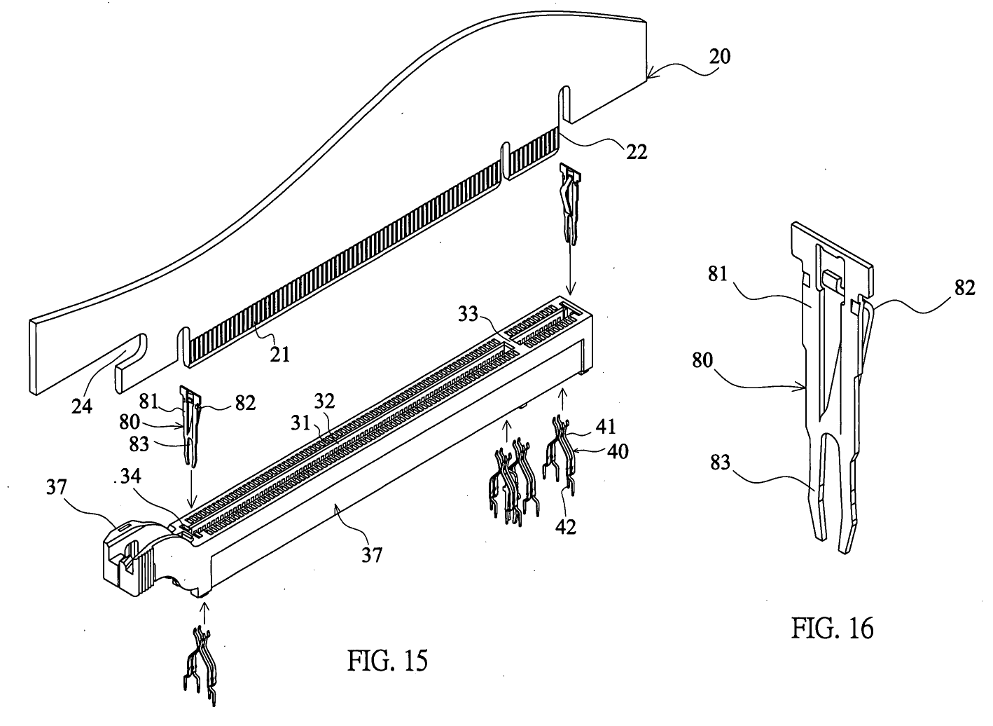

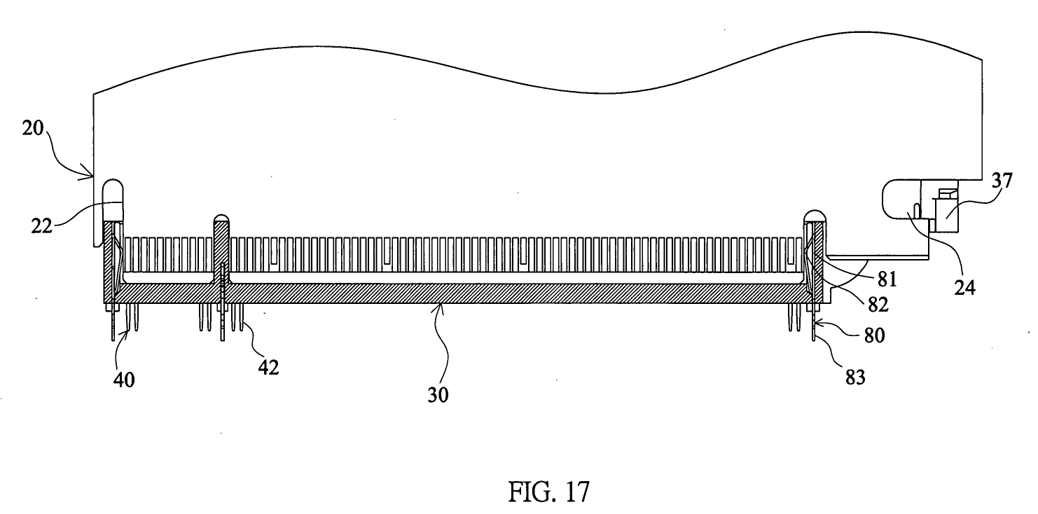

As shown in FIGS. 15 to 17, the eighth embodiment of the invention is almost the same as the first embodiment and the eighth and first embodiments pertain to the same type of electrical connector to be connected to an edge-card-type circuit board 20. The connection points 21 are disposed on two edge surfaces of the circuit board 20, and one side of the circuit board 20 is formed with a notch 24. The connector includes a plastic base 30, terminals 40 and two elastic pressing members 80.

The plastic base 30 having a longitudinal shape has two rows of terminal slots 31 and a longitudinal connection slot 32 between the two rows of terminal slots 31. The opening of the connection slot 32 faces upwards such that the circuit board 20 can be inserted, from top to bottom, for connection. The plastic base 30 is formed with a spacer 33 for dividing the connection slot 32 into two regions with different sizes. Two sides of the connection slot 32 are formed with slots 34. In addition, an engaging device 37 is disposed at one side of the connection slot 32.

The terminal 40 is disposed in the terminal slot 31 of the plastic base 30 and has an elastic contact 41 to be electrically connected to the connection point 21 of the circuit board 20 and a pin portion 42 extending out of the bottom of the plastic base 30.

The two elastic pressing members 80 made of the metal material are fixed in the slots 34 of the plastic base 30. Each elastic pressing member 80 is integrally formed with a fixing portion 81, an elastic arm 82 and a board engaging portion 83. The fixing portion 81 is fixed to the slot 34. The elastic arm 82 is pressed out from the middle of the fixing portion 81 and can elastically press the lateral side 22 of the circuit board 20. The board engaging portion 83 disposed on the bottom of the fixing portion includes two elastic hooks with a gap formed therebetween. The board engaging portion 83 passes through the bottom of the plastic base 30 and may be engaged with the hole of the bonded circuit board.

Because the elastic pressing members 80 of this embodiment are integrally formed with the elastic arms 82 and the board engaging portions 83, they can clamp the circuit board 20 inserted into the connection slot 32 and engage with another circuit board to be bonded to the connector. Thus, two board engaging elements can be omitted.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An electrical connector to be connected to a circuit board having two edge surfaces, on which connection points are disposed, the electrical connector comprising:
a plastic base having a longitudinal shape, two rows of terminal slots, and a longitudinal connection slot between the two rows of terminal slots, wherein the connection slot has an opening facing upwards such that the circuit board can be inserted, from top to bottom, for connection; and
a plurality of terminals disposed in the terminal slots of the plastic base, wherein:
each of the terminals has an elastic contact to be electrically connected to one of the connection points of the circuit board, and a pin portion extending out of a bottom of the plastic base;
at least one elastic pressing member, which is electrically disconnected from the connection points of the circuit board and thus from the circuit board, is disposed on the plastic base; and
the at least one elastic pressing member has at least one elastic arm pressing against the circuit board.

2. The connector according to claim 1, wherein the at least one elastic arm presses against a lateral side of the circuit board, and the lateral side of the circuit board is substantially perpendicular to the edge surfaces of the circuit board.

3. The connector according to claim 1, wherein the at least one elastic arm presses against one of the edge surfaces of the circuit board.

4. The connector according to claim 1, wherein the at least one elastic pressing member and the plastic base are integrally formed.

5. The connector according to claim 1, wherein the at least one elastic pressing member is made of a metal material and assembled on the plastic base.

6. The connector according to claim 5, wherein a bottom of the at least one elastic pressing member is integrally formed with a board engaging portion, which passes through the bottom of the plastic base so as to engage with a hole of the circuit board.

7. The connector according to claim 6, wherein the board engaging portion comprises two elastic hooks spaced apart from each other by a gap.

8. The connector according to claim 1, wherein one side of the plastic base is formed with an engaging device, which movably engages with one side of the circuit board to prevent the circuit board from being separated from the plastic base in an upward direction.
